(19) United States
(12) Patent Application Publication
(10) Pub. No.: US 2018/0170673 A1
(43) Pub. Date: Jun. 21, 2018

(54) SYSTEMS AND METHODS FOR MULTI-UNIT DWELLING STORAGE

(71) Applicant: David Seeley, Eden Prairie, MN (US)

(72) Inventor: David Seeley, Eden Prairie, MN (US)

(21) Appl. No.: 15/843,408

(22) Filed: Dec. 15, 2017

Related U.S. Application Data
(60) Provisional application No. 62/435,511, filed on Dec. 16, 2016.

(51) Int. Cl. B65G 1/137

(52) U.S. Cl. CPC B65G 1/137; G06Q 50/12

(57) ABSTRACT

A koncierge managing facility includes a space for storage, wherein the space is restricted from access; an optical sensor, wherein the optical sensor is configured to capture a plurality of parameters of each of a plurality of property items; a property item identity generator, wherein the property item identity generator generates a unique identity for each of the plurality of property items; a plurality of storage bins, wherein each of the plurality of storage bins includes a bin identifier; a storage unit, the storage unit having sufficient space to contain the plurality of storage bins, the storage unit including a marker; and a control system including a processor and a machine-readable memory accessible by the processor.

### CROSS-REFERENCE TO RELATED APPLICATIONS

This application claims the benefit of U.S. Provisional Application No. 62/435,511, filed Dec. 16, 2016. The contents of the aforementioned application is incorporated herein in its entirety for all purposes.

### FIELD OF THE INVENTION

The present application relates to storage or bailment systems and methods. More particularly, the present application relates to containerized storage or bailment systems and methods. Still more particularly, the present application relates to accessible containerized storage or bailment systems and methods allowing ready access to personal items and or equipment.

### BACKGROUND OF THE INVENTION

The storage industry has long since been focused on providing storage for people that reside in a multi-tenant dwelling where such people have not had the room for things. Common usage for storage facilities has been during moves or transitions, where items are being stored until a user arrives at a more permanent location that is large enough to manage the amount of things possessed by the user. For example, a person that is between residences and is living in a smaller apartment, for example, may rent a storage facility to store their items until the new residence is available. A whole host of circumstances may give rise to the need for this type of storage. This type of storage may be provided by way of a garage space or an internal climate controlled location, for example.

In other cases, people may store items because they simply do not have the space necessary to keep the item in their residence or because they do not want the items in that space. In these circumstances, the accessibility of the items may be a higher priority because, while not present at the residence, the item or items may play a regular role in the user's life.

For these accessibility reasons, a system of photo inventoried storage was developed that allows for accessibility of items that are held in storage. As described, in U.S. Pat. No. 7,778,880, entitled Systems and Methods for Remote Access to Stored Items, and filed Jan. 24, 2006, the content of which is hereby incorporated by reference herein in its entirety.

The disclosure herein provides improvements of the storage system by streamlining the request for storing property items and request for retrieval thereof. The streamlining is done by using various devices and technologies, including optical sensors, computer-controlled mobile drive unit, identification generator, scanners, and various item parameter recognition technologies. The disclosure herein provides image inventoried storage systems that provide for a user to peruse their stored items, select, one or more items, and have the items pulled from storage and held in a location for pickup or retrieval. In this way, a user may have more access to their stored items than if the items were stored in a garage type facility, for example. The user may be able to see the items without visiting the facility and may also more easily retrieve the items. Nonetheless, retrieval of items requires planning due to the amount of time it takes for items to be retrieved. The koncierge managing facility disclosed herein includes the benefit that the transport service may operate as a form of “koncierge” for users' or clients' storage needs, where a user or client may provide items to be stored, and may then request those items be delivered as needed whenever and wherever. The koncierge may operate at least somewhat on an on-demand basis, to deliver a clients' stored item(s) upon request. In this way, users or clients may have ready and convenient access to their stored items, but may have the security and peace of mind of a secure storage system providing for a much larger storage opportunity than that which is available within their apartment or condo, for example. In addition, the user or client may also have peace of mind knowing that their personal items are close by and at a location that they themselves are comfortable living. The users or clients may also appreciate that they are familiar with the individuals and people that are handling their personal items. Still further, the amount of storage space available to the resident may be variable allowing the residents to utilize as much space as they need and to utilize such space for as long as they desire.

In this disclosure, a transport service responding to user request to deliver and retrieve the storage bins may be referred as “Koncierge” or “Koncierge managing system.” The storage bins and containers may be referred as “Kases”.

### SUMMARY OF THE INVENTION

The present application relates to storage or bailment systems and methods. More particularly, the present application relates to containerized storage or bailment systems and methods. Still more particularly, the present application relates to accessible containerized storage or bailment systems and methods allowing ready access to personal items and or equipment.

According to one embodiment of the disclosure, a koncierge managing facility may include a space for storage, wherein the space is restricted from access; an optical sensor, wherein the optical sensor is configured to capture a plurality of parameters of each of a plurality of property items; a property item identity generator, wherein the property item identity generator generates a unique identity for each of the plurality of property items; a plurality of storage bins, wherein each of the plurality of storage bins includes a bin identifier; a storage unit, the storage unit having sufficient space to contain the plurality of storage bins, the storage unit including a marker; and a control system including a processor and a machine-readable memory accessible by the processor. The control system being configured to receiving, by the processor, a message to store the plurality of property items, wherein the message includes the plurality of parameters of each of the plurality of property items and the unique identity for each of the plurality of property items; determining, by the processor, a number of storage bins required to store the plurality of property items, wherein the determination is made, at least partially, based on the plurality of parameters captured by the optical sensor; and assigning, by the processor, the number of storage bins to the property items; creating, by the processor, a partition in the machine-readable memory, the partition is configured to store a mapping between the unique identities of the plurality of property items and the bin identifiers of the storage bins.

According to one embodiment, a koncierge managing facility may includes a space for storage, wherein the space being restricted from access; a plurality of storage bins, wherein each of the plurality of storage bins includes a bin identifier; a storage unit, wherein the storage unit has sufficient space to contain the plurality of storage bins; the storage unit includes a marker; and a control system including a processor and a machine-readable memory accessible by the processor. The control system being configured to receiving, by the processor, a message to retrieve the plurality of property items, wherein the message a unique identity for each of the plurality of property items; and determining, by the processor, storage bins that contain the plurality of property items, wherein the determination is made, at least partially, based on a mapping between the unique identities of the plurality of property items, bin identifiers of the storage bins, and markers of storage units.

### BRIEF DESCRIPTION OF THE DRAWINGS

FIG. 1 is a schematic view of a koncierge managing system with storage units according to one embodiment of the disclosure.

FIG. 2 is an illustrative example of a graphical user interface of a koncierge managing system according to one embodiment of the disclosure.

FIG. 3 is a schematic drawing of a processing center of a koncierge managing facility according to one embodiment of the disclosure.

FIG. 4 is a block diagram of a control system of a koncierge managing facility according to one embodiment of the disclosure.

FIG. 5 is a block diagram of a control system of a koncierge managing facility according to one embodiment of the disclosure.

FIG. 6 is a method processed by a koncierge managing facility according to one embodiment of the disclosure.

FIG. 7 is a method processed by a koncierge managing facility according to one embodiment of the disclosure.

FIG. 8 is a method processed by a koncierge managing facility according to one embodiment of the disclosure.

FIG. 9 is a method processed by a koncierge managing facility according to one embodiment of the disclosure.

FIG. 10 is a method processed by a koncierge managing facility according to one embodiment of the disclosure.

FIG. 11 is a method processed by a koncierge managing facility according to one embodiment of the disclosure.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

The present application is focused on further advancing storage and accessibility. For example, in one or more embodiments, a storage system may be provided onsite, so to speak. That is, and particularly in multi-unit dwellings, a storage facility, room, or other space may be provided onsite such as within the building, in an adjacent building, or in a relatively accessible location avoiding the use of public roadways and the like. The storage system disclosed herein may also be located in an office building, a retail store, a shopping mall, a sorting facility, a hotel or the like.

In addition, the storage system may include containers or units that may be rented, leased, purchased, or provided as an amenity by or to the residents of the dwelling. The residents may store items in the containers and may rely on transport services to retrieve and/or deliver their containers from or to the storage facility. The transport services may be a limited group of persons or systems that can access the storage facility thereby increasing the security of the storage facility. Due to the physical proximity of the storage location, access may be provided readily, in a short amount of time and avoiding the need for prior planning.

Examples of multi-unit dwellings for which a system or method of the present disclosure may be used may be an apartment building or complex, a condominium building or complex, a resort, hotel, or motel, or other residential dwellings where there is a desire by residents to store personal items.

Residents of a multi-unit dwelling may store individual personal items and/or containers or groups of personal items. Residents may pack a container, box, or other vessel to be stored in some embodiments. For example, a resident may request an empty container for storing items. In other embodiments, the resident may simply release items to a third party, such as a transport service, with instructions to store the items.

In some embodiments, a resident or dwelling may have one or more associated storage containers or storage spaces. For example, a resident may own, rent, or otherwise be associated with one or more whole containers of storage space that the user may use for storing items. In some embodiments, a storage container may be associated with a plurality of residents or dwellings. For example, where residents or dwellings store items individually, the items for such residents or dwellings may be grouped into a single storage container, room, space, or other container for storing. Storage containers may be associated with residents or dwellings before or after items are placed within the containers. In some embodiments, storage containers or storage space may be provided to residents or dwellings as an amenity of a multi-unit dwelling.

A transport service may include one or more third parties with access to stored items. For example, a transport service may include a third party transport company or employees thereof, a storage company or employees thereof, an employee, owner, or contractor of the multi-unit dwelling, or another party. In some embodiments, the transport service may own the storage site and the containers or the transport service may rent the storage site from the dwelling and provide the containers and the service and in other embodiments, the transport service may simply provide the delivery and storage service and not own or rent the storage location or the containers.

In some embodiments, the stored items may be stored in a secured manner or facility. For example, each storage space, storage unit, storage bin, box, container, or other vessel containing residents' items may be accessible by way of a key, keycard, access card, access code, fingerprint, or other secure identifier. In some embodiments, only the resident whose items are in a container may have access to the particular container. For example, the storage bins or containers includes security device that can only be released by proper authentication, e.g., passcode, fingerprint, etc. Additionally or alternatively, the transport service, including individuals who retrieve or maintain stored items, for example, may have access to the storage bins or containers. In some embodiments, where for example multiple residents' items are stored in a single container, only the transport service, e.g., koncierge personnel, may have access to the container. Additionally or alternatively, the storage facility or other space where the storage bins and containers are maintained may be similarly accessible using one or more security identifiers. In some embodiments, only authorized individuals, such as authorized transport service individuals, e.g., koncierge personnel, who retrieve and/or maintain stored items may have access to the storage facility. In other embodiments, owners, managers, workers, or others associated with the multi-unit dwelling may have access to the storage facility. In this way, systems and methods of the present disclosure may provide for a secure storage option, with varying levels of security, depending on the needs of the particular facility, dwelling, residents and/or other users.

In this way, the transport service may operate as a form of “koncierge” for residents' storage needs, where a resident may provide items to be stored, and may then request those items be delivered as needed. The term “koncierge” has the same meaning as “concierge.” The koncierge may operate at least somewhat on an on-demand basis, to deliver a resident's stored item(s) upon request. In this way, users or clients may have ready and convenient access to their stored items, but may have the security and peace of mind of a secure storage system providing for a much larger storage opportunity than that which is available within their apartment or condo, for example. In addition, the user or client may also have peace of mind knowing that their personal items are close by and at a location that they themselves are comfortable living. The users or clients may also appreciate that they are familiar with the individuals and people that are handling their personal items. Still further, the amount of storage space available to the resident may be variable allowing the residents to utilize as much space as they need and to utilize such space for as long as they desire.

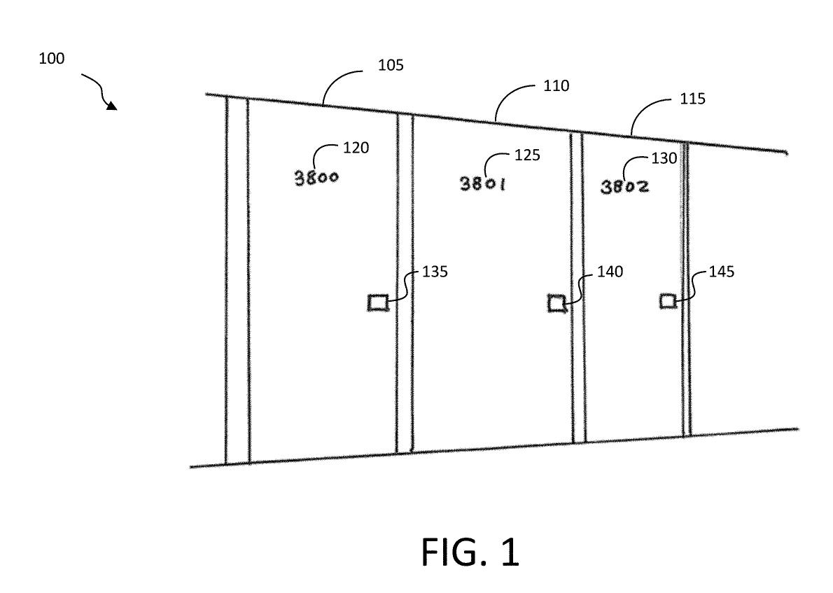

FIG. 1 is a schematic view of a koncierge managing facility 100 with storage units 105, 110, 115 according to one embodiment of the disclosure. As shown in FIG. 1, a koncierge managing facility 100 includes multiple storage units 105, 110, 115. The storage units 105, 110, 115 can be a confined space. In another embodiment, the storage units 105, 110, 115 can be a rack or shelve, e.g., storage unit 302. In yet another embodiment, the storage units 105, 110, 115 can be movable. For example, if the storage unit is a rack (e.g., 302), the rack can be moved by a mobile drive unit (e.g., 306) for processing a request for either storing or retrieving purposes.

Each of the storage units 105, 110, 115 may include a marker 120, 125, 130, respectively. The markers 120, 125, 130, may be numbers as shown in FIG. 1. In other embodiments, the markers can be a symbol, a bar code, a text, or the like that uniquely identifies one storage unit from another.

Each of the storage units 105, 110, 115 may include a security measure 135, 140, 145, respectively. The security measure 135, 140, 145 may be a combination of a lock, a keycard reader, a keypad, a fingerprint reader, a voice recognition device, an iris scanner, etc.

A client may be assigned to one or more storage units. In another embodiment, a storage unit may be shared by a plurality of clients.

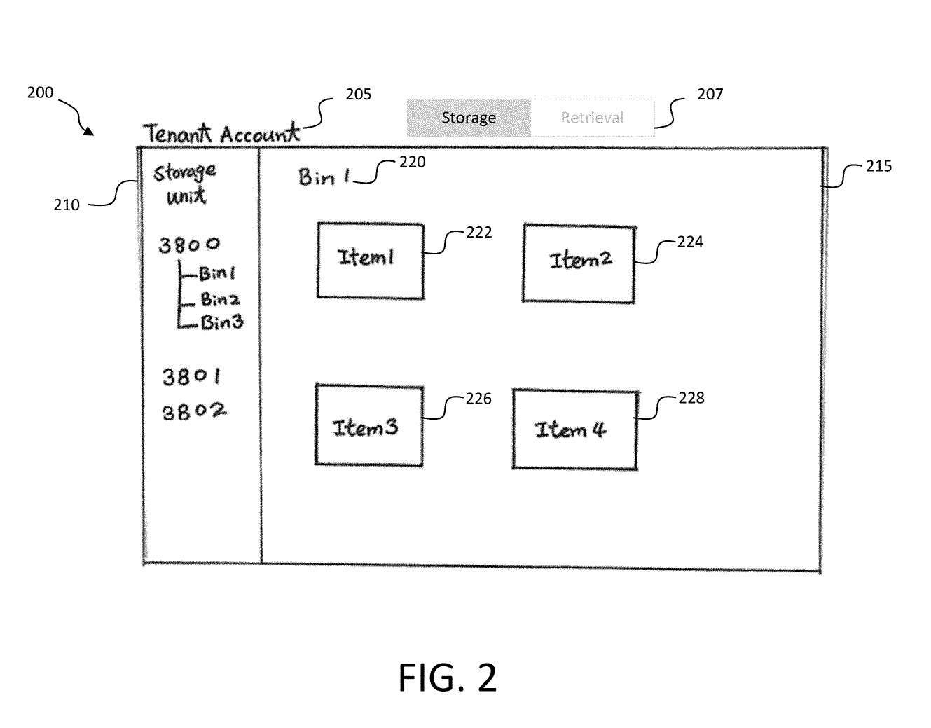

FIG. 2 is an illustrative example of a graphical user interface (GUI) 200 of a koncierge managing system according to one embodiment of the disclosure. As shown in FIG. 2, the GUI 200 represents an account of a tenant (i.e., user, client) 205. The GUI 200 can be used for both making a request to store property items and a request to retrieve the stored property items 207.

The GUI includes a left panel 210 and a right panel 215. The left panel 210 is a navigation panel that shows a tree structure of storage units used by the tenant. The left panel also shows the storage bins stored within the storage units. The tree structure is constructed based on the mapping relationship maintained by a koncierge managing facility.

When a specific storage bin is selected, e.g., bin 1 stored in storage unit 3800, then images 222, 224, 226, 228 of the property items stored within that specific bin are displayed on the right panel 215. Such visual representation of the pictures or images of the property items helps the property owner to easily recognize the property items desired.

When the tenant requests to store property items, the GUI 200 highlights the “storage” section on storage/retrieval tab 207. The GUI 200 may start with a bin and a storage unit that is available at the koncierge facility for assignment, e.g., Bin 1 and storage unit 3800. The GUI 200 allows the tenant to drag and drop images of the property items the tenant desires to store. The images can be taken by the tenant himself or downloaded from a commercial database. In one embodiment, the GUI 200 further allows the tenant to input the dimensions of the property items, e.g., length, width, height. In another embodiment, the GUI 200 would communicate with a koncierge managing facility which would analyze the images and automatically identify the make/model of the property item as well as its dimensions. The GUI 200 would automatically populate another bin, e.g., Bin 2, if the current storage bin, e.g., Bin 1, is full. The determination of whether a storage bin is full is calculated, at least in part, based on the dimensions of the property items and the dimensions of the storage bins. Further, if a storage unit, e.g., storage unit 3800, is full, the GUI 200 would automatically populate another storage unit, e.g., storage unit 3801. Similarly, the determination of whether the storage unit 3800 is full is, at least in part, based on the dimensions of the storage bins and the dimensions of the storage units.

When the tenant is requesting to retrieve a stored property item, the GUI 200 highlights the “retrieval” section of the storage/retrieval tab 207. The GUI 200 will represent all the storage units and storage bins used by the tenant on the left panel 210. The items stored in the storage bin that is selected by the tenant on the left panel 210 are shown on the right panel 215. The presentation of the items 222, 224, 226, 228 are shown as images, e.g., photo taken by the tenant using a camera. When an item is selected the GUI 200 will inform the koncierge managing facility about the identity of the property item, the bin number, and the storage unit number for further processing.

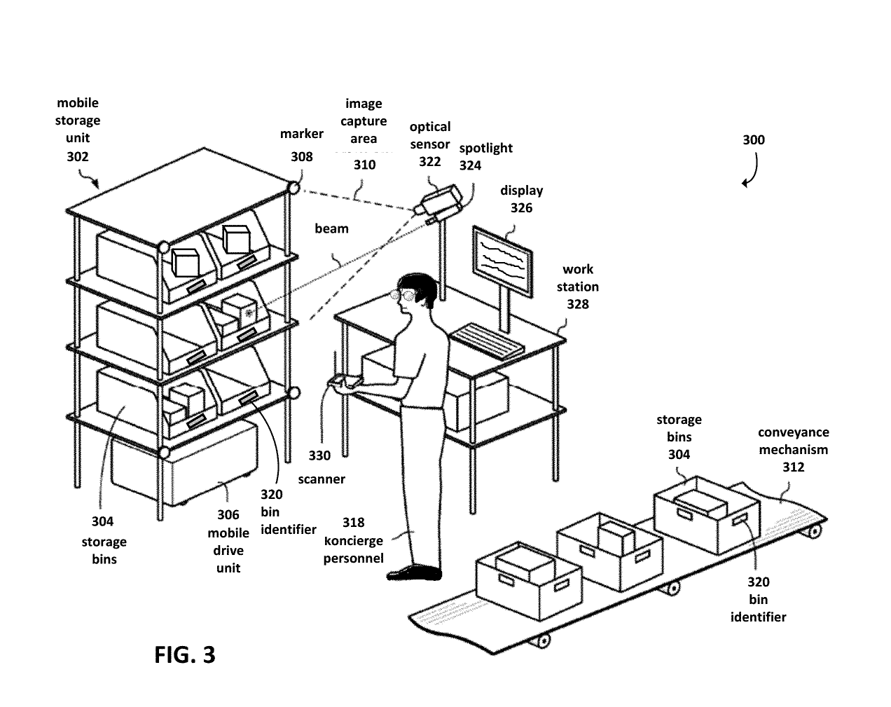

FIG. 3 is a schematic drawing of a processing center 300 of a koncierge managing facility according to one embodiment of the disclosure. As shown in FIG. 3, the storage unit 302 can be a rack. The rack is movable by a mobile drive unit 306. The mobile drive unit can be automatically controlled by the koncierge managing facility. In one embodiment, when a request for retrieval is received by the koncierge managing facility, a control system can automatically bring the requested storage unit to a processing center where koncierge personnel 318 is located. The storage unit 302 includes the bins that store the requested property items. The storage unit 302 includes a marker 308 that distinguishes itself from other storage units. The storage unit includes a plurality of storage bins 304. Each of the storage bins includes a bin identifier 320. The bin identifier 320 can be captured by a scanner 330 or an optical sensor 322.

The koncierge managing facility includes a work station 328. The work station 328 includes a display 326. The display 326 can show the images of the property items requested by the client. The work station 328 includes an optical sensor 322 and a spotlight 324. The optical sensor 322 has an image capture area 310. The optical sensor 322 captures the images of the bin identifiers 320 of the storage bins 304.

In one embodiment, the koncierge managing system may read the retrieval request from a client. The koncierge managing system may further read the partition of the machine-readable medium that stores the mapping between the property items and the storage bins as well as the mapping between storage bins and the storage units. The optical sensor 322 may scan the bin identifiers 320 of storage bins 304 and identify the storage bin 304 that contains the property items requested by the client. This identification is done, at least partially, based on the mapping data stored previously. Once the specific bin that contains the requested property item is identified by the koncierge managing control system, the control system may direct the spotlight 324 to highlight the storage bin. Such highlighting of the bins helps to direct the attention of the koncierge personnel 318 and reduce the time required to identify the correct storage bins.

Further, in one embodiment, the koncierge personnel will use the scanner 330 at his/her hand to scan the bin identifier 320 of the highlighted storage bin 304. This is to double check that the correct storage bin 304 is identified. The Koncierge personnel may further move the storage bins 304 on a conveyance mechanism 312.

In one embodiment, the conveyance mechanism 312 may be a conveyance belt. In another embodiment, the conveyance mechanism 312 can be a dolly.

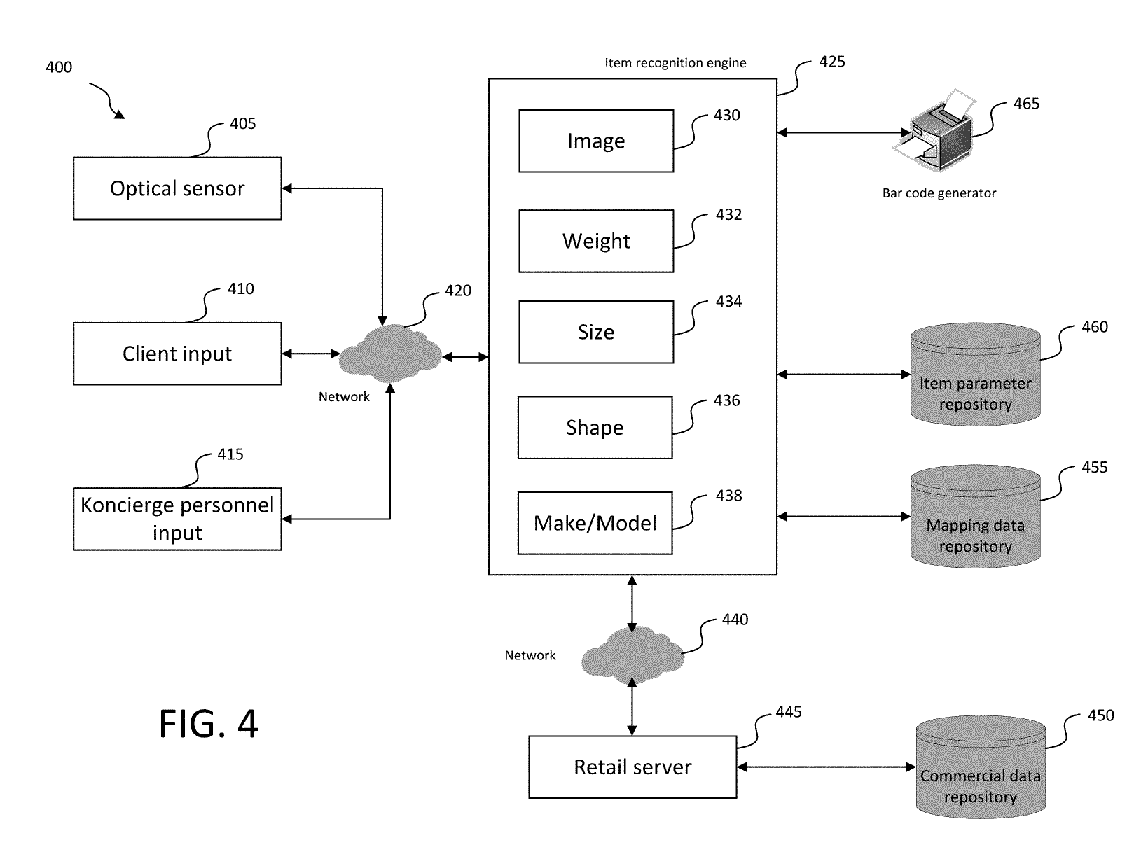

FIG. 4 is a block diagram of a control system 400 of a koncierge managing facility according to one embodiment of the disclosure. The control system 400 includes an optical sensor 405, client input means 410, and koncierge personnel input means 415. The optical sensor 405, client input means 410, and koncierge personnel input means 415 are connected to a network 420.

The network 420 is connected to an item recognition engine 425. The item recognition engine collects parameters of a property item. The parameters of a property item includes an image 430, weight 432, size 434, shape 436, and make/model 438.

In one embodiment, the client can use an optical sensor 405, e.g., a camera, to take a picture of the item he/she desired to store. This picture can be uploaded to the item recognition engine 425 through the network 420. In one embodiment, the item recognition engine 425 can automatically analyze the picture and identify the make/model of the property item. In one embodiment, the item recognition engine 425 may also automatically search a retail server 445 for the identified property items. Once found on the retail server 445, the item recognition engine 425 may pull parameters of the item from commercial data repository 450. The parameters pulled from commercial data repository 450 may include weight 432, size 434, shape 436, and make/model 438. In such embodiments, the client only need to upload a picture of the item, other parameters of the items are automatically collected by the item recognition engine 425.

In one embodiment, the item recognition engine 425 may receive the parameters of the property items from client input 410. In yet another embodiment, the item recognition engine 425 may receive the parameters of the property items from koncierge personnel input 415.

After the item recognition engine 425 collects all the parameters of the items to be stored, the koncierge control system will assign appropriate numbers of storage bins and storage units to the client to fulfill the specific request for storage. The item recognition engine 425 stores all the parameters in the item parameter repository 460. The item recognition engine 425 stores all the mapping among property items, storage bins, and storage units in the mapping data repository 455.

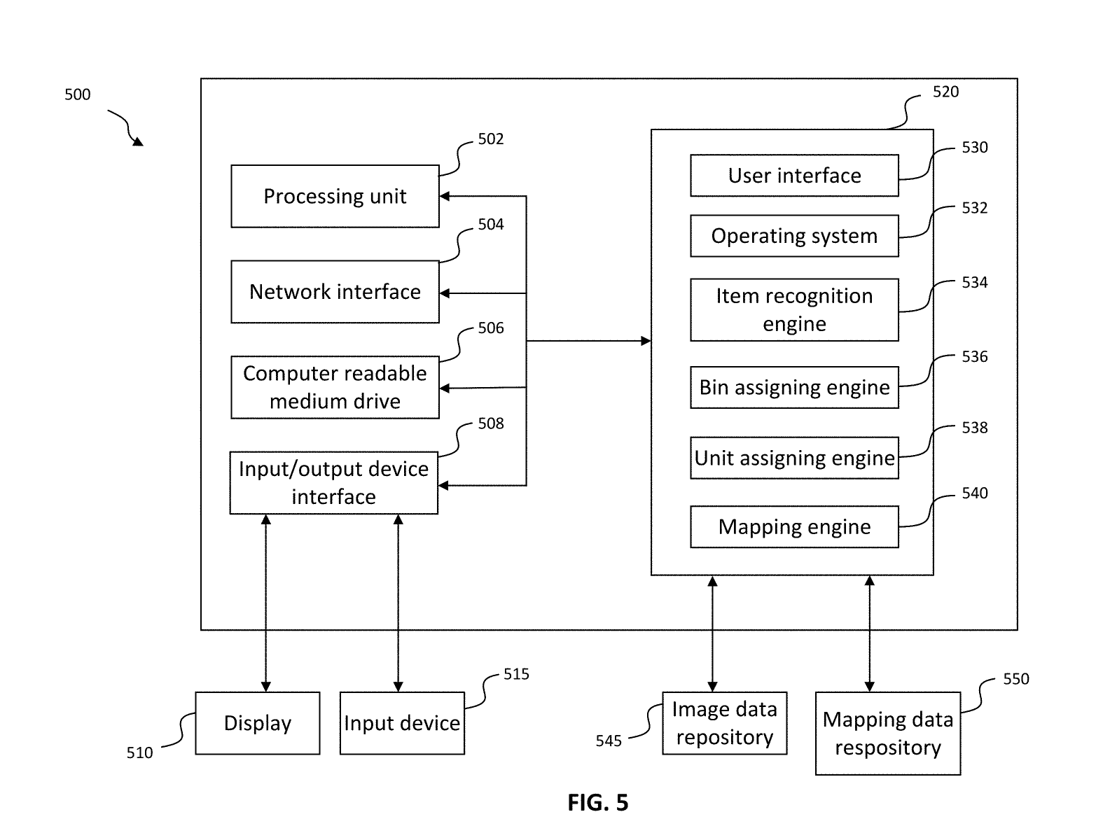

FIG. 5 is a block diagram of a control system 500 of a koncierge managing facility according to one embodiment of the disclosure. FIG. 5 depicts a general architecture of a control system 500 of a koncierge managing facility. The general architecture of the control system 500 includes an arrangement of computer hardware and software components that may be used to implement aspects of the present disclosure. The control system 500 may include many more (or fewer) elements than those shown in FIG. 5. It is not necessary, however, that all of the generally conventional elements be shown in order to provide an enabling disclosure. As illustrated, the control system 500 includes a processing unit 502, a network interface 504, a computer readable medium drive 506, an input/output device interface 508, a display 510, and an input device 515, all of which may communicate with one another by way of a communication bus.

The network interface 504 may provide connectivity to one or more networks or computing systems. The processing unit 502 may thus receive information and instructions from other computing systems or services via a network. The processing unit 502 may also communicate to and from memory 520 and further provide output information for an optional display 510 via the input/output device interface 508. The input/output device interface 508 may also accept input from the optional input device 515, such as a keyboard, mouse, digital pen, microphone, touch screen, gesture recognition system, voice recognition system, etc.

The memory 520 may contain computer program instructions (grouped as modules or components in some embodiments) that the processing unit 502 executes in order to implement one or more embodiments. The memory 520 generally includes RAM, ROM and/or other persistent, auxiliary or non-transitory computer-readable media. The memory 520 may store an operating system 532 that provides computer program instructions for use by the processing unit 502 in the general administration and operation of the control system 500. The memory 520 may further include computer program instructions and other information for implementing aspects of the present disclosure. For example, in one embodiment, the memory 520 includes a user interface module 530 that generates graphical user interfaces (GUIs) (and/or instructions therefor) for display upon a computing device, e.g., via a navigation interface such as a browser or application installed on the computing device. In addition, memory 520 may include or communicate with an auxiliary image data repository 545, mapping data repository 550 and/or one or more other data stores, as discussed above with reference to FIG. 5.

In addition to and/or in combination with the user interface module 530, the memory 520 may include an item recognition engine 534, a bin assigning engine 536 and a unit assigning engine 538 that may be executed by the processing unit 502. In one embodiment, bin assigning engine 536, the unit assigning engine 538 and mapping engine 540 individually or collectively implement various aspects of the present disclosure, e.g., assign proper numbers of storage bins and storage units to satisfy a storage request from a client. The processing unit 502 may store the data processed in the memory 520 in the image data repository 545 and mapping data repository 550.

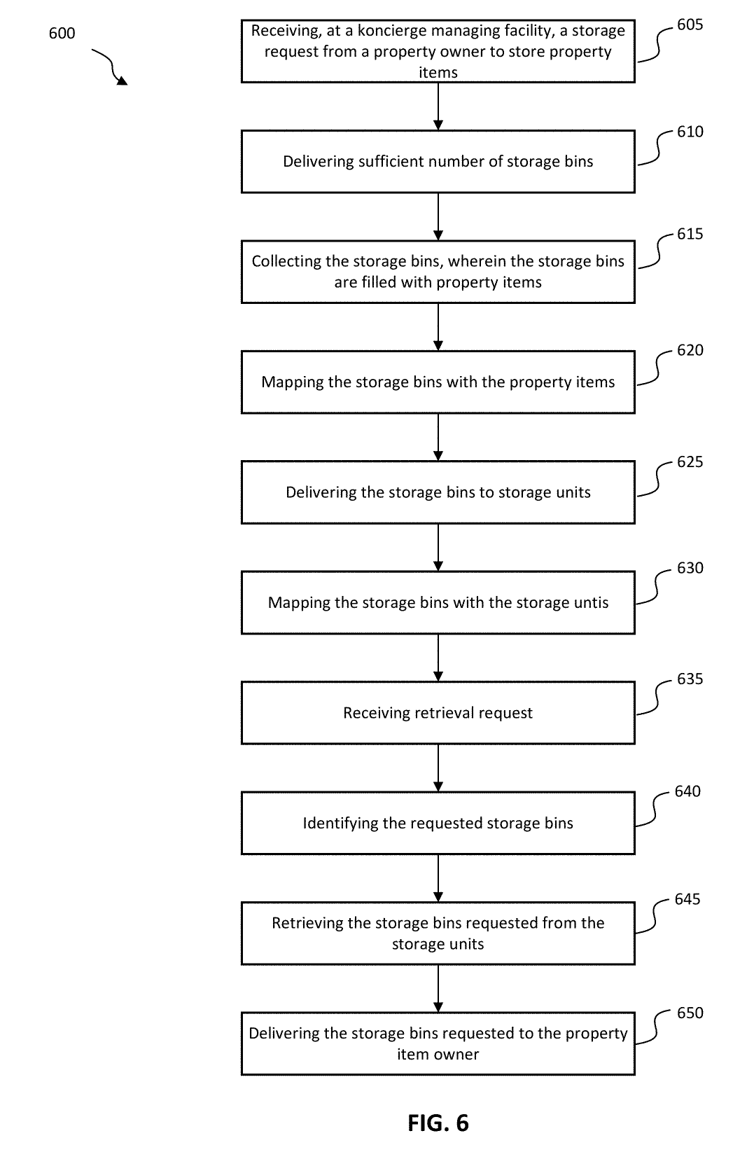

FIG. 6 is a method 600 processed by a koncierge managing facility according to one embodiment of the disclosure. The method 600 includes receiving, at a koncierge managing facility, a storage request form a property owner to store property items 605. The method 600 includes delivering sufficient number of storage bins 610. The method 600 includes collecting the storage bins, wherein the storage bins are filled with property items 615. The method 600 includes mapping the storage bins with the property items 620. The method 600 includes delivering the storage bins to storage units 625. The method 600 includes mapping the storage bins with the storage units 630. The method 600 includes receiving retrieval request 635. The method 600 includes identifying the requested storage bins 640. The method 600 includes delivering the storage bins requested to the property item owner 645.

In step 605, the koncierge managing facility receives a request to store property items. The owner of the property items makes the request. This request can be made using the GUI shown in FIG. 2. The request may include submitting pictures of the property items to be stored, as well as the parameters of the property items. In another embodiment, only the pictures of the property items are submitted and the item recognition engine 425 shown in FIG. 4 automatically recognizes the parameters based on the pictures.

In step 610, the method 600 delivers sufficient numbers of the storage bins 610. In one embodiment, to ensure sufficient number of storage bins are delivered, the control system of the koncierge managing facility calculates the total space needed for the property items and determines a sufficient number of storage bins to be delivered. This calculation is done at least partially based on the parameters of the property items.

In step 610, the property owner may specify where he/she wants the storage bins to be delivered. In one embodiment, the storage bins may be delivered to a residence, an office, a tennis court, a golf course, or the like. In another embodiment, the property owner may specify a place him/herself to pick up, e.g., a designated place of the koncierge managing facility, a service center, or the like.

In step 615, the koncierge managing facility may pick up the filled storage bins. In this step, the place for pickup may be different from the place that storage bins were dropped off. In step 615, a koncierge personnel may be tasked to perform the pick-up. In another embodiment, at the time the storage bins were picked up, the koncierge personnel uses an optical sensor, e.g., a camera, a handheld scanner, etc., to scan an identifier (e.g., bar codes) of the storage bins. The koncierge managing facility may automatically send a confirmation message to the property owner informing the property owner that the storage bins are picked up.

In step 620, the control system of the koncierge managing facility may create a partition to store the mapping of the storage bins and the property items. In other embodiments, the mapping between the storage units and the storage bins can also be stored.

In step 625, as an example, the koncierge personnel may deliver the storage bins to storage units. Once delivered, the koncierge managing facility would record the check-ins of the storage bins.

In step 630, the koncierge managing facility would record the mappings among the property items, the storage bins, and the storage units. The control system of the koncierge managing facility may send a confirmation message to the property owner about the check-ins. The confirmation message may include the mappings among the property items, storage bins, and the storage units.

In step 635, the property owner may send a request to retrieve the property items. This request can be made using the GUI shown in FIG. 2. The request may include submitting pictures of the property items to be retrieved.

In step 640, the koncierge managing facility identifies the storage bins and the storage units where the requested property item is stored. This identification is done, at least partially, based on the mapping data.

In step 645, the koncierge managing facility may direct the koncierge personnel to retrieve the storage bins requested. This step may include the technologies and processes disclosed in FIG. 3.

In step 650, the koncierge personnel may deliver the storage bins to the property owner. The property owner may specify anywhere for the storage bins to be delivered, e.g., residence, office, tennis court, golf course, or the like. In another embodiment, the storage bins may be delivered to a place for the property owner to pick up.

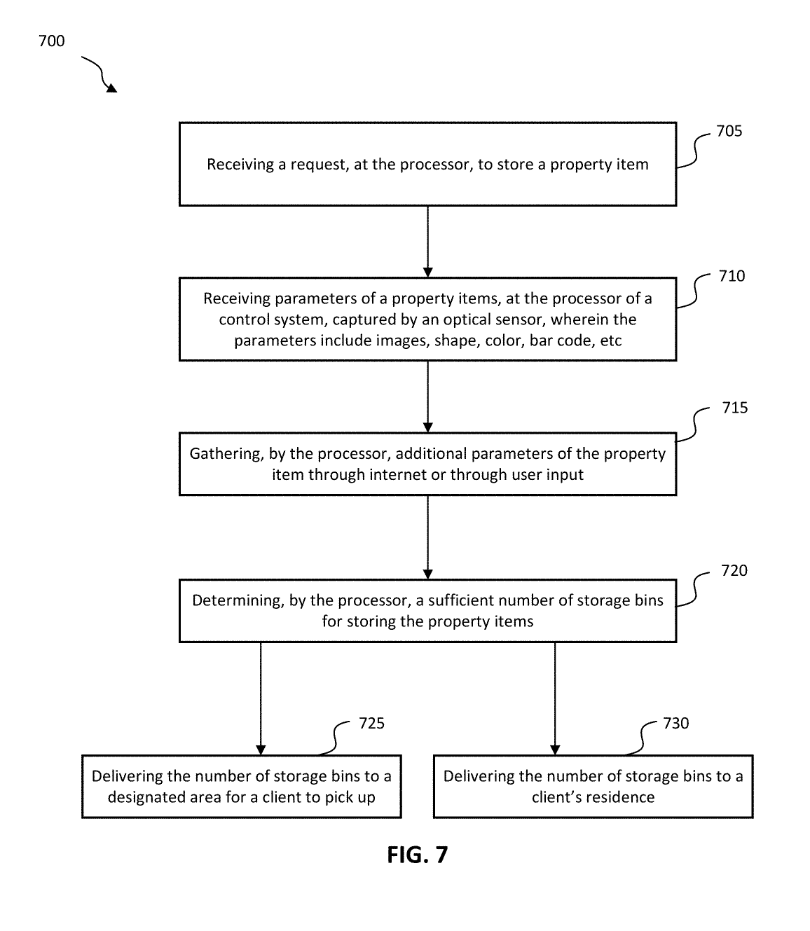

FIG. 7 is a method 700 processed by a koncierge managing facility according to one embodiment of the disclosure. The method 700 includes receiving a request, at the processor, to store property items 705. The method 700 includes receiving parameters of a property items, at the processor of a control system, captured by an optical sensor, wherein the parameters include images, shape, color, bar code, etc. 710. The method 700 includes gathering, by the processor, supplemental information of the property item through internet or through user input 715. The method 700 includes determining, by the processor, a sufficient number of storage bins for storing the property items 720. The method 700 includes delivering the number of storage bins to a designation area for a client to pick up 725. The method includes delivering the number of storage bins to a client's residence 730.

In step 710, the parameters may be the picture of the property item, the dimensions, the size, the weight, the shape, the make/model, or the like. In one embodiment, the user may only submit the pictures of the property items, the koncierge managing system may automatically gather the additional parameters at step 715. At step 715, the user may be someone other than the client, e.g., koncierge personnel, can provide the additional parameters.

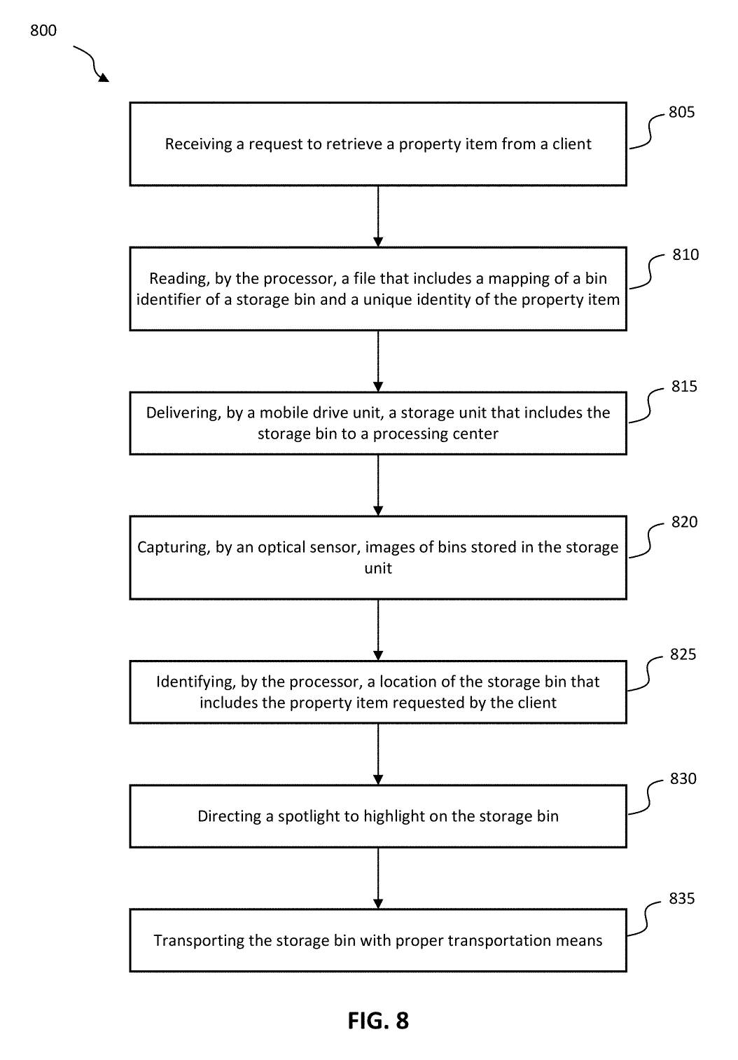

FIG. 8 is a method processed by a koncierge managing facility according to one embodiment of the disclosure. The method 800 includes receiving a request to retrieve a property item from a client 805. The method 800 includes reading, by the processor, a file that includes a mapping of a bin identifier of a storage bin and a unique identity of the property item 810. The method 800 includes delivering, by a mobile drive unit, a storage unit that includes the storage bin to a processing center 815. The method 800 includes capturing, by an optical sensor, images of bins stored in the storage unit 820. The method 800 includes identifying, by the processor, a location of the storage bin that includes the property item requested by the client 825. The method 800 includes directing a spotlight to highlight on the storage bin 830. The method 800 includes transporting the storage bin with proper transportation means 835.

The method 800 is a process to retrieve the proper storage bin upon a client's retrieval request. The technologies and methods disclosed in FIG. 3 may be applicable to method 800.

In step 810, the proper storage bin that has the property item requested is identified. In step 815, the mobile drive unit delivers the storage unit to a processing center. In step 820, the optical sensor, e.g., a camera, may scan the storage bins stored in the storage unit. In step 825, the control system locates the bin. In step 830, the control system may direct a spotlight to highlight the storage bin. In step 835, the koncierge managing facility transports the storage bin with proper transportation means, e.g., man, dolly, conveyance platform, or the like.

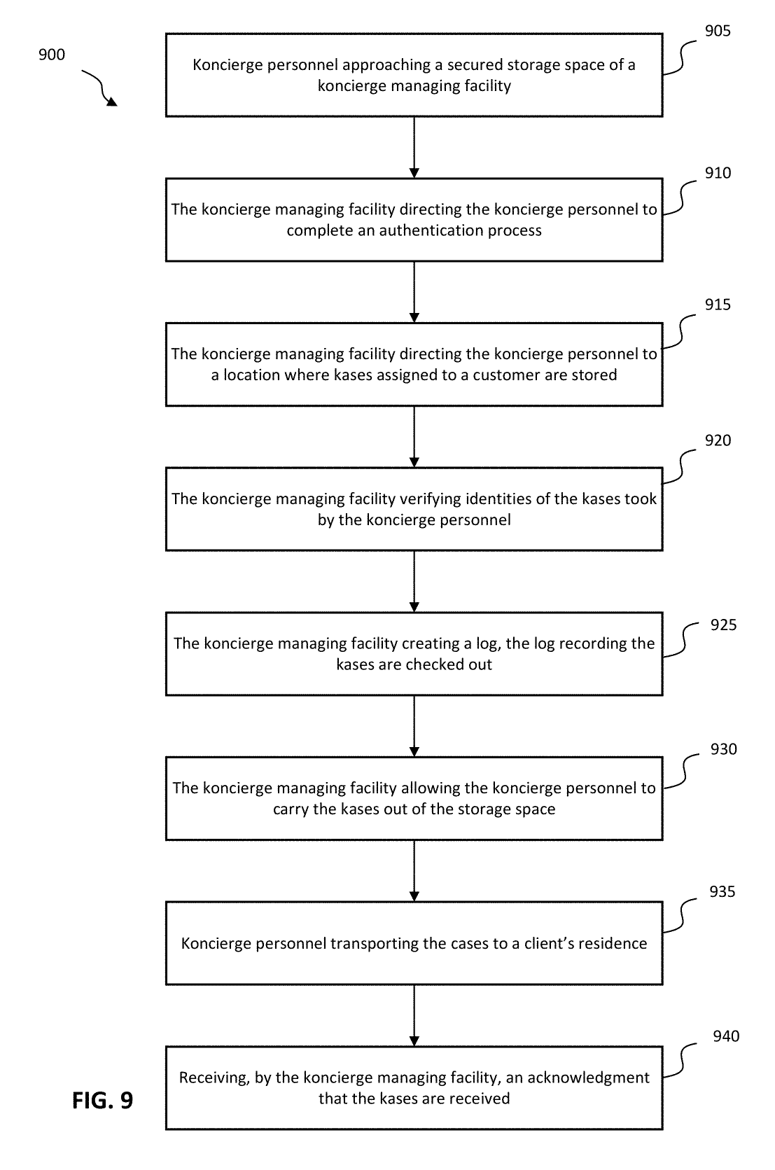

FIG. 9 is a method 900 processed by a koncierge managing facility according to one embodiment of the disclosure. Method 900 includes koncierge personnel approaching a secured storage space of a koncierge managing facility 905. In one embodiment, the security measure may include a lock, a key pad, a fingerprint scanner, a voice recognition device, etc.

The method 900 includes the koncierge managing facility directing the koncierge personnel to complete an authentication process 910. Method 900 includes the koncierge managing facility directing the koncierge personnel to a location where kases assigned to a customer are stored 915. The term “kases” are identical to “storage bins” used in this disclosure.

Method 900 includes the koncierge managing facility verifying identities of the kases took by the koncierge personnel 920. Method 900 includes the koncierge managing facility creating a log, the log recording the kases are checked out 925. Method 900 includes the koncierge managing facility allowing the koncierge personnel to carry the kases out of the storage space 930. Method 900 includes koncierge personnel transporting the cases to a client's residence 935. Method 900 includes receiving, by the koncierge managing facility, an acknowledgment that the kases are received 940.

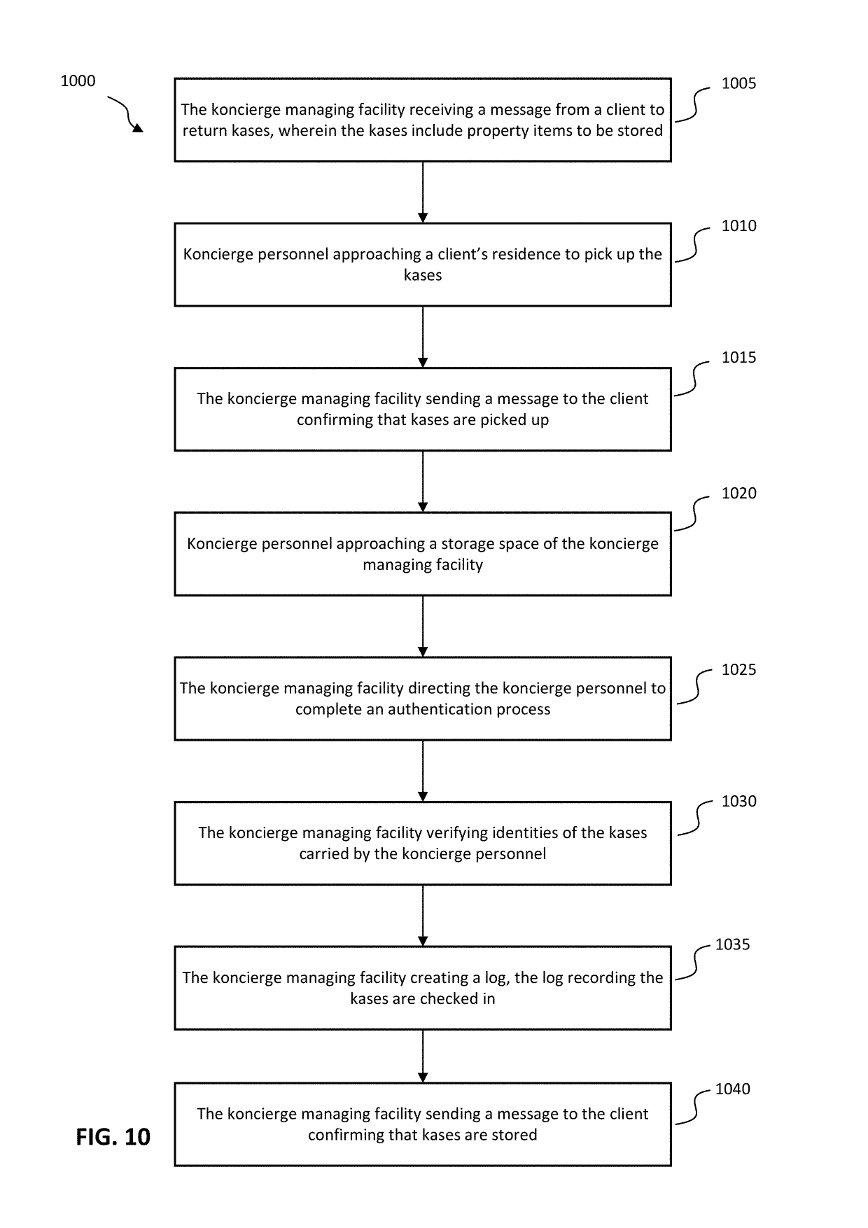

FIG. 10 is a method 1000 processed by a koncierge managing facility according to one embodiment of the disclosure. The method 1000 includes the koncierge managing facility receiving a message from a client to return kases, wherein the kases include property items to be stored 1005. The method 1000 includes koncierge personnel approaching a client's residence to pick up the kases 1010. The method 1000 includes the koncierge managing facility sending a message to the client confirming that kases are picked up 1015. The method 1000 includes the koncierge personnel approaching a storage space of the koncierge managing facility 1020. The method 1000 includes koncierge managing facility directing the koncierge personnel to complete an authentication process 1025. The method 1000 includes the koncierge managing facility verifying identities of the kases carried by the koncierge personnel 1030. The method 1000 includes the koncierge managing facility creating a log, the log recording the kases are checked in 1035. The method 1000 includes the koncierge managing facility sending a message to the client confirming that kases are stored 1040.

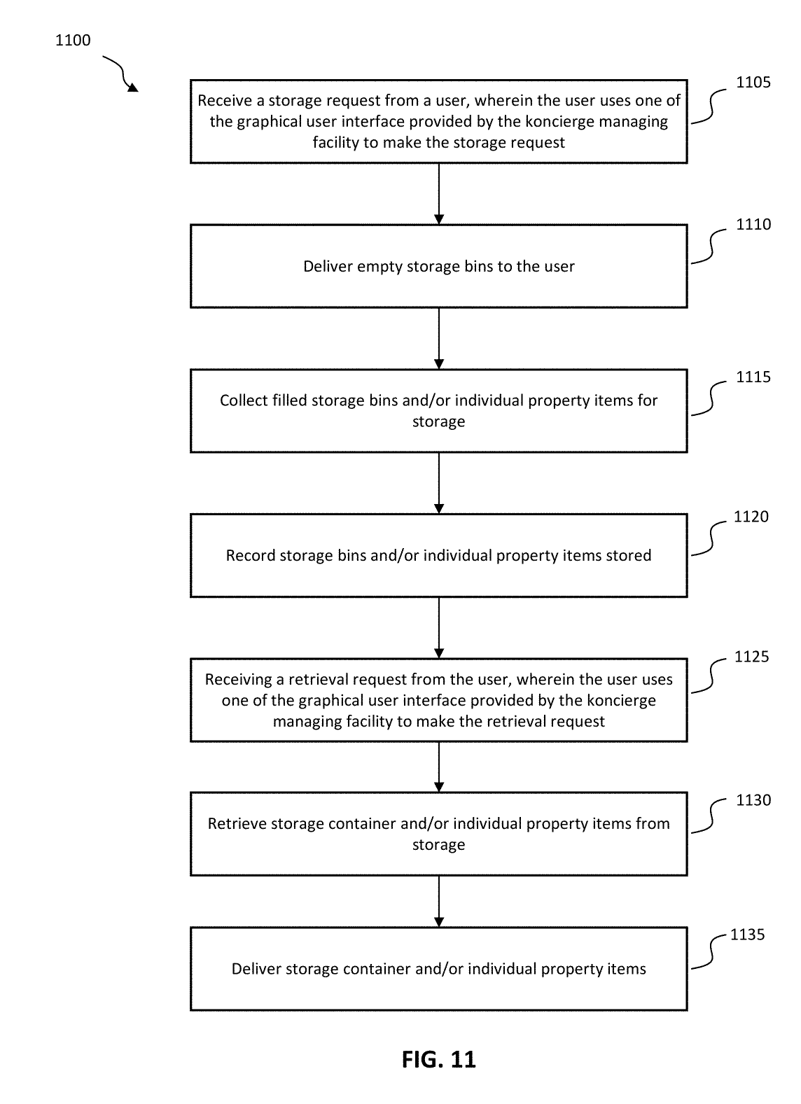

FIG. 11 is a method 1100 processed by a koncierge managing facility according to one embodiment of the disclosure. As shown, the method 1100 may include receiving a storage request 1105, delivering an empty storage bin 1110, collecting a filled storage bin and/or individual items for storage 1115, storing the storage bin and/or individual items 1120, receiving a retrieval request 1125, retrieving the storage bin and/or individual items from storage 1130, and delivering the container and/or individual items 1135.

Receiving a storage request 1105 may include receiving a request from a dwelling unit or resident. The request 1105 may be for an empty storage bin in some embodiments. In other embodiments, the request 1105 may simply be a request to store one or more items. In still other embodiments, the request 1105 may be for delivery of an already used, but unfilled container. The user uses one of the graphical user interface (GUI), e.g., FIG. 2, provided by the koncierge managing facility to make the storage request 1105. In addition to the GUI, the request 1105 may be made using any suitable means, such as by filling out an Internet request form, by phone, by email, by text, or by any other suitable communication means.

Step 1110 is to deliver empty storage bins to the user. The delivery can be done by a transport service, e.g., koncierge personnel. In some embodiments, a transport service or other concierge or third party may respond to the request by delivering an empty storage bin, or in some cases, delivering a storage bin already assigned to the resident, which may be at least partially full for example. The resident may then place items into the storage bin. Once the resident is finished filling the storage bin, the resident may notify the transport service or other party via any suitable communication means. During this storage process, and where a partially filled container is delivered to the resident, the resident may, for example, remove items from the container as well as adding new items to the container.

In step 1115, the transport service or other party may return to collect the storage bin now containing the resident's item(s) for storage. Step 1115 may be done after a predetermined time after step 1110, or upon a request by the resident. In other embodiments, where for example the resident's request 1105 was to store a particular item(s), the transport service or other party may collect the particular item(s) to be stored for the resident. That is, in some embodiments, the resident may place his or her item(s) in a storage bin, while in other embodiments, the resident may individually give items to the transport service or another third party, which may then place the items in a storage bin for storage. In other situation, the resident's property items may not fit into a storage bin, e.g., a music instrument, a golf club set, a large furniture, etc.

In step 1120, the koncierge management system may maintain a record of the items stored in a storage bin associated with the resident. In some cases, the resident may provide a list of items in the container or otherwise to be stored. In other embodiments, the koncierge management system or other party may create a list. Additionally or alternatively, in some embodiments, the koncierge management system or other party may use photo inventorying to document the items stored. For example, the koncierge management system or other party or the resident may take one or more photos of the item(s) to be stored. In some embodiments, the photo inventory record may be made available to the resident whose items are stored, such that the resident may have easy access to a visual record. In one particular embodiment, the easy access is implemented through the GUI as shown in FIG. 2.

In step 1120, once ready for storage, the koncierge management system or other party may place the item(s) and/or storage bin in the storage facility. Generally, items and/or containers may be transported by any suitable means, such as by a wheeled cart or dolly for example, by manually being carried, by drone or other unmanned vehicle or device, or by any other suitable means. As described above, the storage facility may be a local storage facility, such that the items may be stored in a same building or complex as the dwelling, or a relatively short distance away, such as a nearby building or complex. In step 1120, the koncierge management system or other party may maintain a record associating the resident and/or dwelling with the particular storage bin where the item(s) are being stored. In some embodiments, a record of the storage bin's (or items') location within the storage facility may also be maintained.

As mentioned above, the resident may have ready access to his or her stored item(s) on an on-demand basis. That is, based on a record of what is in each container of a resident, the resident may be able to access a particular container or set of containers by requesting retrieval of a container or set from the transport service. In this way, at step 1125, the koncierge management system or other third party may receive a retrieval request from the resident for a container, containers, or for one or more particular stored items. The user uses one of the graphical user interface (GUI), e.g., FIG. 2, provided by the koncierge managing facility to make the retrieval request 1125. In other embodiments, the retrieval request 1125 may be made using any suitable means, such as by filling out an Internet request form, by phone, by email, by text, or by any other suitable communication means.

In step 1130, the koncierge management system or other party may respond to the retrieval request 1125 by retrieving the requested storage bin, containers, or individual stored item(s) from the storage facility, and delivering the same to the resident. It may be appreciated that the amount of time between a resident placing a request for a stored item or container, and the delivery of such requested item or container to the resident may be a relatively short period of time. The on-site or relatively local location of the storage facility may facilitate ready, on-demand access to stored items. Residents may receive stored items in a matter of hours or even minutes of a submitted request in some embodiments.

Step 1135 includes delivering storage bins and/or individual property items. Still further, in some embodiments, the koncierge service may deliver the storage bins or items to a desired location. The desired location may, in one or more embodiments, be a use-based location where the user may use the items in the container, e.g., golf clubs to a golf course, tennis rackets to a tennis court. In other embodiments, the location may simply be a location of choice of the user. For example, where the resident is requesting towels, the transport service may also be asked to deliver the towels poolside, for example. In other situations, the transport service may deliver items to a carport or garage, for example, when the resident plans to clean his/her car or otherwise desires the container to be delivered there. In still other embodiments, the transport service may deliver the container to the front of the facility, to the golf facility, or other amenity-type location. In some embodiments, the transport service may deliver the personal item container to the exercise room, weight room, or other facility. In some embodiments, the transport service may deliver the container to a laundry facility, for example where the resident has detergent, bleach, or other laundry items in a stored container. In one or more embodiments, the transport service may retrieve containers from one or more of the above locations as well.

It is to be appreciated that the koncierge managing system may also coordinate delivery and/or retrieval from offsite locations where, for example, third party pick-up and delivery services are used by the transport service to deliver or retrieve a container to or from locations outside the of the multiunit dwelling grounds, for example.

Systems and methods described herein may provide for secure, convenient, and readily accessible storage. It may be appreciated that the systems and methods of the present disclosure may leverage the local or on-site location of the storage facility to provide residents with ready access to stored items. In this way, residents may have the opportunity to store items outside of their dwelling space, in order to reduce clutter and/or store items more securely, without the need to access an off-site or remote storage facility, and without the wait time generally involved in obtaining items from such remote facilities. For example, in some embodiments, the system may function as an extension of a residents dwelling like another closet, pantry, garage, basement, or other location where items may otherwise be stored. In some embodiments, for example, a user may request that the transport service deliver containers when he/she returns from shopping or grocery shopping so the user can remove food or other items from the container that the user plans to use sooner and placing newly purchased items in the container that the user wants to store for later use. Still other approaches to the system may be for seasonal rotation of clothing, ready access to sporting equipment such as golf clubs, kayaks, bikes, canoes, hunting equipment, or other items. Still another approach may be for seasonal access to sporting equipment. Still other uses may include storage of games where a user may request delivery of a container on game night or storage of seasonal decor and the like.

Although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

What is claimed is:

1. A koncierge managing facility, comprising:
a space for storage, the space being restricted from access;
an optical sensor, the optical sensor being configured to capture a plurality of parameters of each of a plurality of property items;
a property item identity generator, the property item identity generator generating a unique identity for each of the plurality of property items;
a plurality of storage bins, wherein each of the plurality of storage bins includes a bin identifier;
a storage unit, the storage unit having sufficient space to contain the plurality of storage bins, the storage unit including a marker; and
a control system including a processor and a machine-readable memory accessible by the processor, the control system being configured to
receiving, by the processor, a message to store the plurality of property items, wherein the message includes the plurality of parameters of each of the plurality of property items and the unique identity for each of the plurality of property items;
determining, by the processor, a number of storage bins required to store the plurality of property items, wherein the determination is made, at least partially, based on the plurality of parameters captured by the optical sensor; and
assigning, by the processor, the number of storage bins to the property items;
creating, by the processor, a partition in the machine-readable memory, the partition is configured to store a mapping between the unique identities of the plurality of property items and the bin identifiers of the storage bins.

2. The koncierge managing facility according to claim 1, wherein the koncierge managing facility is located within at least one of the following locations:
an apartment building, an office building, a retail store, a shopping mall, a sorting facility, and a hotel.

3. The koncierge managing facility according to claim 1, wherein the control system is further configured to
authorizing a client or koncierge personnel to access the space, after an authentication process is completed.

4. The koncierge managing facility according to claim 1, further comprising
a storage bin delivering system, the storage bin delivering system arranging a delivering process to deliver the storage bins assigned.

5. The koncierge managing facility according to claim 4, wherein the delivering process includes
a koncierge personnel, the koncierge personnel is configured to deliver the storage bins assigned.

6. The koncierge managing facility according to claim 4, wherein the delivering process includes
delivering the storage bins assigned to a designated area for a client to pick up.

7. The koncierge managing facility according to claim 1, further comprising
performing an authentication process to verify an identity of a client, before authorizing the client to pick up the storage bins assigned.

8. The koncierge managing facility according to claim 7, wherein the authentication process includes
an optical scanner, the optical scanner is configured to scan a bar code associated with a client or a biometric feature of the client.

9. The koncierge managing facility according to claim 1, wherein the control system is further configured to
assigning, by the processor, a storage unit to the number of storage bins, wherein the storage unit has a marker, the marker identifies the storage unit.

10. The koncierge managing facility according to claim 9, wherein the control system is further configured to
creating, by the processor, a partition in the machine-readable memory, the partition is configured to store a mapping between the marker of the storage unit and the bin identifiers of the storage bins.

11. A koncierge managing facility, comprising:
a space for storage, the space being restricted from access;
a plurality of storage bins, wherein each of the plurality of storage bins includes a bin identifier;
a storage unit, the storage unit having sufficient space to contain the plurality of storage bins; the storage unit includes a marker; and
a control system including a processor and a machine-readable memory accessible by the processor, the control system being configured to
receiving, by the processor, a message to retrieve the plurality of property items, wherein the message a unique identity for each of the plurality of property items; and
determining, by the processor, storage bins that contain the plurality of property items, wherein the determination is made, at least partially, based on a mapping between the unique identities of the plurality of property items, bin identifiers of the storage bins, and markers of storage units.

12. The koncierge managing facility according to claim 11, wherein the koncierge managing facility is located within at least one of the following locations:
an apartment building, an office building, a retail store, a shopping mall, a sorting facility, and a hotel.

13. The koncierge managing facility according to claim 11, wherein the control system is further configured to
authorizing a client or koncierge personnel to access the space, after an authentication process is completed.

14. The koncierge managing facility according to claim 11, further comprising
a storage bin delivering system, the storage bin delivering system arranging a delivering process to deliver the storage bins.

15. The koncierge managing facility according to claim 14, wherein the delivering process includes
a koncierge personnel, the koncierge personnel is configured to deliver the storage bins.

16. The koncierge managing facility according to claim 14, wherein the delivering process includes
delivering the storage bins to a designated area for a client to pick up.

17. The koncierge managing facility according to claim 14, wherein the delivering process includes

18. a mobile drive unit that is configured to automatically carry the a storage unit to a designated area. The koncierge managing facility according to claim 11, further comprising
performing an authentication process to verify an identity of a client, before authorizing the client to pick up the storage bins.

19. The koncierge managing facility according to claim 18, wherein the authentication process includes
an optical scanner, the optical scanner is configured to scan a bar code associated with a client or a biometric feature of the client.

20. The koncierge managing facility according to claim 11, wherein the control system is further configured to
sending a confirmation message to a client that the plurality of property items are in the process of deliverance.
